(19) United States
(12) Patent Application Publication
(10) Pub. No.: US 2013/0147910 A1
(43) Pub. Date: Jun. 13, 2013

(54) MOBILE DEVICE AND IMAGE CAPTURING METHOD

(71) Applicant: Yang XIN, Shenzhen City (CN)

(72) Inventor: Yang XIN, Shenzhen City (CN)

(73) Assignees: HON HAI PRECISION INDUSTRY CO., LTD., Tu-Cheng (TW); Fu Tai Hua Industry (Shenzhen) Co., Ltd., ShenZhen City (CN)

(21) Appl. No.: 13/337,314

(22) Filed: Dec. 27, 2011

(30) Foreign Application Priority Data
Dec. 9, 2011 (CN) 201110408359.9

(51) Int. Cl. H04N 5/247

(52) U.S. Cl. 348/38; 348/E05.048

(57) ABSTRACT

A mobile device includes at least two cameras, a comparison circuit, and an image processor. The at least two cameras simultaneously capture at least two images, and the at least two images have at least one overlapping portion. The comparison circuit compares data of the at least two images and generates a comparison result according to the comparison. The image processor processes at least one of the at least two images, identifies the at least one overlapping portion, and merges the at least two images to form an integrated image, according to the comparison result.

### BACKGROUND

1. Technical Field

The present disclosure generally relates to mobile devices, and particularly to a mobile device having a wide-angle image capturing function and an image capturing method.

2. Description of Related Art

Most of mobile devices, such as mobile phones, have a camera function. However, because of limited costs and configurations of a mobile phone, viewing angle of a camera of the mobile phone and an image quality of a picture taken by the camera is inferior to those of professional cameras.

What is needed, therefore, is a mobile device which can overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic block diagram of a mobile device according to an exemplary embodiment, and the mobile device includes two cameras.

FIG. 2 is a schematic view of image capturing areas of the two cameras of FIG. 1.

FIG. 3 is a schematic flowchart of an image capturing method of the mobile device of FIG. 1 according to one embodiment.

### DETAILED DESCRIPTION

Reference will be made to the drawings to describe the embodiments in detail.

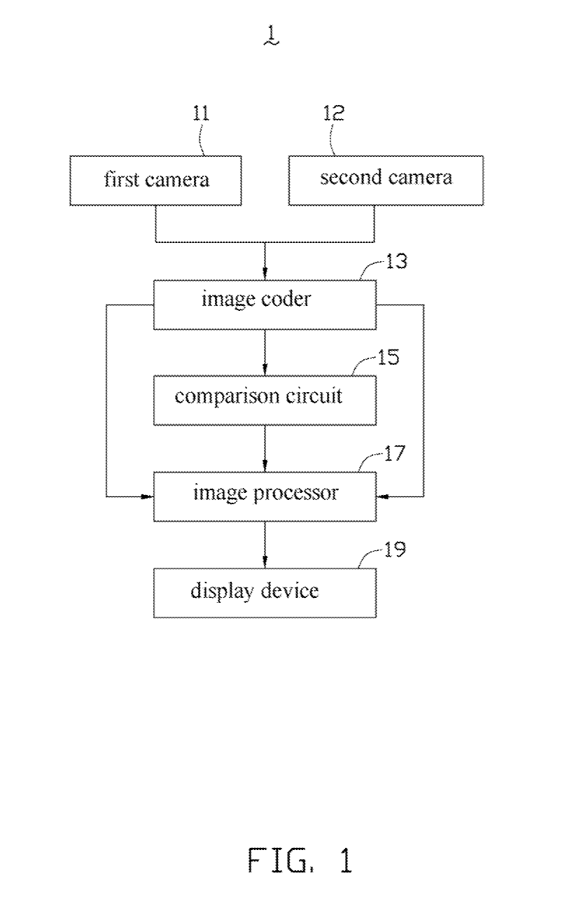

FIG. 1 is a schematic block diagram of a mobile device 1 according to an embodiment. In this embodiment, the mobile device 1 may be a mobile phone, and includes a first camera 11, a second camera 12, an image coder 13, a comparison circuit 15, an image processor 17, and a display device 19. In other embodiments, the mobile device 1 may be a video device.

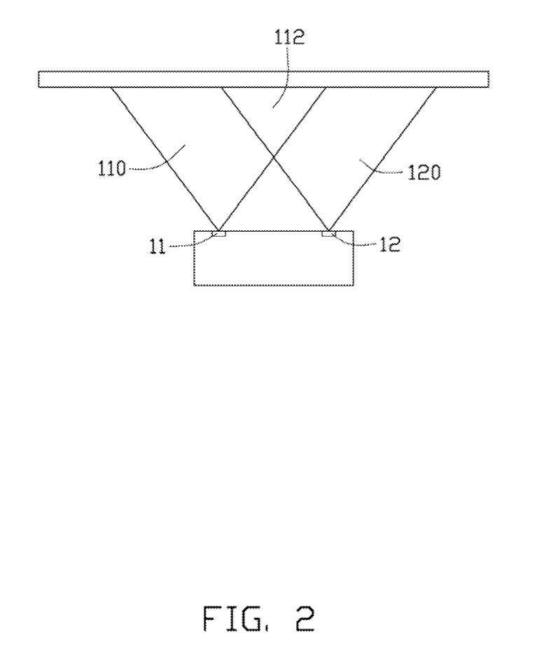

The first and second cameras 11, 12 capture images simultaneously. Assembling positions of the cameras 11, 12 on the mobile device 1 can be designed according to actual requirements, and meet conditions that the images captured by the cameras 11, 12 must have an overlapping portion. In FIG. 2, a first image capturing area captured by the camera 11 is defined as a first area 110, and a second image capturing area captured by the camera 12 is defined as a second area 120. The first and second areas 110, 120 have an overlapping area 112. The camera 11 captures a first image corresponding to the first area 110, and generates a first image signal. The camera 12 captures a second image corresponding to the second area 120, and generates a second image signal. The first and second images have an overlapping portion corresponding to the overlapping area 112. The cameras 11, 12 further provide the first and second image signals to the image coder 13.

The image coder 13 encodes the first and second image signals according to a uniform coding standard, and provides the encoded first and second image signals to the comparison circuit 15 and the image processor 17.

The comparison circuit 15 compares data of the first and second images, and further compares image parameters of the first and second images. The image parameters may include a resolution ratio, a brightness, a contrast ratio, a chroma, and other parameters representing an image quality. The comparison circuit 15 compares at least one image parameter of the first image with that of the second image. The comparison circuit 15 further generates a comparison result according to the comparison, and provides the comparison result to the image processor 17.

The image processor 17 may be a digital signal processor, and identifies the overlapping portion, merges the first and second images, and forms an integrated image according to the comparison result. That is, the image processor 17 generates a third image signal corresponding to the integrated image according to the first and second image signals. The integrated image is an image generated by the first image removing the overlapping portion and then adding the second image or the second image removing the overlapping portion and then adding the first image.

The processor 17 further processes the first and/or second images according to the comparison result. In particular, the processor 17 defines one of the first and second images as a reference image according to the comparison result, and adjusts the image parameter of the other one of the first and second images according to that of the reference image. For example, if the comparison circuit 15 just compares one image parameter, such as the resolution ratio, of the first image with that of the second image, the processor 17 determines that the resolution ratio of the first image is superior to that of the second image, then the processor 17 defines the first image as the reference image, and adjusts the resolution ratio of the second image according to the resolution ratio of the first image. In an alternative embodiment, the processor 17 can further adjust other image parameters, such as the brightness and the contrast ratio, of the second images according to those corresponding image parameters of the first image.

For another example, if the comparison circuit 15 compares two or more image parameters of the first image with those of the second image, the processor 17 defines that the reference image is one of the first and second images having at least two image parameters superior to those of the other one of the first and second images, and then adjusts the two or more image parameters of the other one of the first and second images according to those of the reference image.

In an alternative embodiment, if the comparison circuit 15 compares two or more image parameters of the first image with those of the second image, the processor 17 defines one of the first and second images as the reference image by determining one image parameter at one time. For example, if the comparison circuit 15 respectively compares the resolution ratio and the brightness of the first image with those of the second image, if the processor 17 determines that the resolution ratio of the first image is superior to that of the second image, the processor 17 defines the first image as the reference image, and adjusts the resolution ratio of the second image according to the resolution ratio of the first image. If the processor 17 further determines that the brightness of the second image is superior to that of the first image, the processor 17 defines the second image as the reference image, and adjusts the brightness of the first image according to the brightness of the second image.

In one embodiment, the processor 17 can process the images according to a software algorithm.

Therefore, the integrated image merged by the processed first and/or second images has an improved quality.

The display device 19 receives the third image signal and displays the integrated image.

In summary, due to the two cameras 11, 12 simultaneously capturing images, the mobile device 1 can capture wider angle image than a mobile device just having one camera. Referring to FIG. 2 again, when the mobile device 1 just uses the camera 11 to capture an image, the captured area merely equals the first area 110. When the mobile device 1 just uses the camera 12 to capture an image, the captured area merely equals the second area 120. However, when the mobile device 1 simultaneously uses the cameras 11, 12 to capture images, the captured area can cover the first and second areas 110, 120. Furthermore, the image processor 17 adjusts each of the inferior image parameters according to the corresponding superior image parameter of the first and second images. Therefore, the integrated image has an improved quality.

In another embodiment, the comparison circuit 15 compares at least one image parameter of the overlapping portions of the first and second images, and provides a comparison result to the image processor 17. The image processor 17 defines one of the first and second images as a reference image according to the comparison result, and adjusts the image parameters of the other one of the first and second images according to those of the reference image. Especially when the specifications of the two cameras 11, 12 are different, for example, the first camera 11 has a high resolution ratio (e.g., 8 megapixel) and the second camera 12 has a low resolution ratio (e.g., 5 megapixel), an image quality of the first image captured by the first camera 11 is accordingly better than that of the second image captured by the second camera 12. Therefore, the image processor 17 defines the first image as the reference image according to the comparison result, and adjusts the image parameters of the second image according to those of the first image. Thus, the quality of the second image can be improved to be the same as the first image.

Due to the fact that the image processor 17 uses the image captured by one of the first and second cameras 11, 12 having superior specification to adjust the image parameters of the image captured by the other one of the first and second cameras 11, 12 having inferior specification. The mobile device 1 can obtain an integrated image having an improved quality substantially equal to an image captured by both cameras 11, 12 having the same superior specification. Thus, the cost of the mobile device 1 can be saved.

In this embodiment, the mobile device 1 merely employs two cameras 11, 12. In an alternative embodiment, the mobile device 1 can be includes three or more cameras. When the mobile device 1 includes three or more cameras to capture three or more images simultaneously, two images captured by each two adjacent cameras should have an overlapping portion to avoid an integrated image merged by the images captured by all the cameras being incomplete and defective. Furthermore, the image processor 17 defines one of the three or more images as a reference image, and adjusts the image parameters of others of the three or more images according to the reference image.

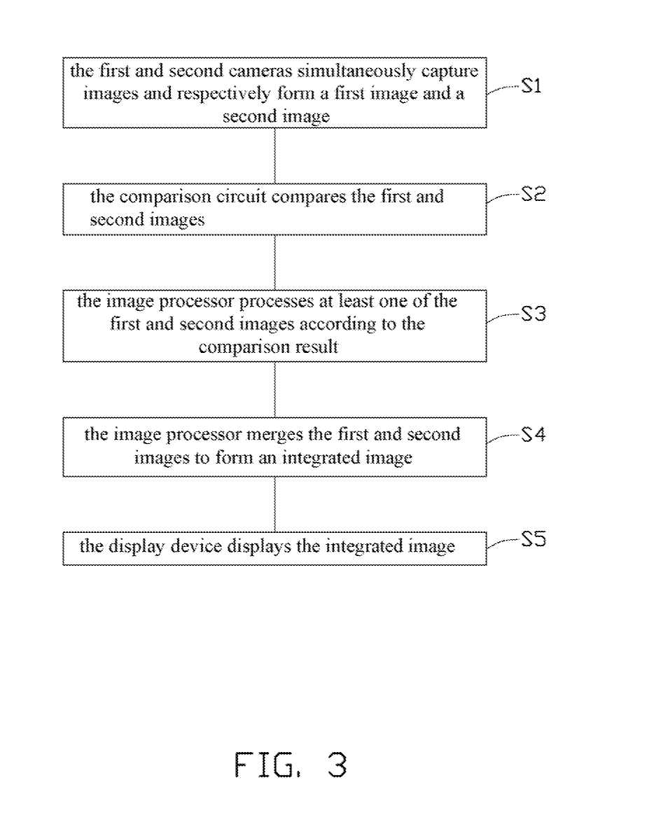

FIG. 3 is a schematic flowchart of an image capturing method of the mobile device 1 according to one embodiment. The image capturing method includes the following steps.

In step S1, the first and second cameras 11, 12 simultaneously capture images and respectively form a first image and a second image. In one embodiment, referring to FIG. 2 again, the camera 11 captures the first area 110 and generates a first image signal corresponding to the first image, and the camera 12 captures the second area 120 and generates a second image signal corresponding to the second image. The first and second images have an overlapping portion corresponding to the overlapping area 112. The cameras 11, 12 further provide the first and second image signals to the image coder 13. The image coder 13 encodes the first and second image signals according to a uniform coding standard, and provides the encoded first and second image signals to the comparison circuit 15 and the image processor 17.

In step S2, the comparison circuit 15 compares the first and second images. In particular, the comparison circuit 15 compares data of the first and second images, and further compares at least one image parameter of the first image with that of the second image. The comparison circuit 15 further generates a comparison result according to the comparison, and provides the comparison result to the image processor 17.

In step S3, the image processor 17 processes at least one of the first and second images according to the comparison result. In particular, the processor 17 defines one of the first and second images as a reference image, adjusts the image parameter of the other one of the first and second images according to that of the reference image. If the comparison circuit 15 compares one image parameter of the first image with that of the second image, for example, the processor 17 determines that the image parameter of the first image is superior to that of the second image, then the processor 17 defines the first image as the reference image, and adjusts the image parameter of the second image according to that of the first image. In an alternative embodiment, the processor 17 can further adjust other image parameters of the second images according to those corresponding image parameters of the first image.

If the comparison circuit 15 compares two or more image parameters of the first image with those of the second image, for example, the processor 17 defines that the reference image is one of the first and second images having at least two image parameters superior to those of the other one of the first and second images, and then adjusts the two or more image parameters of the other one of the first and second images according to those of the reference image.

In an alternative embodiment, if the comparison circuit 15 compares two or more image parameters of the first image with those of the second image, the processor 17 determines that one image parameter of one image is superior to that of the other image at one time, defines the one image as the reference image, and then adjusts the image parameter of the other image according to the image parameter of the reference image. For example, if the comparison circuit 15 respectively compares the resolution ratio and the brightness of the first image with those of the second image, if the processor 17 determines that the resolution ratio of the first image is superior to that of the second image, the processor 17 defines the first image as the reference image, and adjusts the resolution ratio of the second image according to the resolution ratio of the first image. If the processor 17 further determines that the brightness of the second image is superior to that of the first image, the processor 17 defines the second image as the reference image, and adjusts the brightness of the first image according to the brightness of the second image.

In another embodiment, the comparison circuit 15 compares the first and second images, and further compares at least one image parameter of the overlapping portion of the first image with that of the overlapping portion of the second image, and provides a comparison result to the image processor 17. The image processor 17 determines one of the first and second images as a reference image according to the comparison result, and adjusts the image parameters of the other one of the first and second images according to those of the reference image.

In step S4, the image processor 17 merges the first and second images to form an integrated image. In particular, the image processor 17 identifies the overlapping portion, and generates a third image signal corresponding to the integrated image according to the first and second image signals. The integrated image is an image generated by first removing the overlapping portion and then adding the second image or removing the overlapping portion of the second image and then adding the first image.

In an alternative embodiment, the order of performing step S3 and step S4 can be reversed. That is, the image processor 17 can merge the first and second images and then process the first and second images according to the comparison result.

In step S5, the display device 19 displays the integrated image. In particular, the display device 19 receives the third image signal and displays the integrated image.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A mobile device, comprising:
at least two cameras configured to simultaneously capture at least two images, the at least two images having at least one overlapping portion;
a comparison circuit configured to compare data of the at least two images and generate a comparison result according to the comparison; and
an image processor configured to process at least one of the at least two images, identify the at least one overlapping portion, and merge the at least two images to form an integrated image according to the comparison result.

2. The mobile device of claim 1, wherein the comparison circuit is further configured to compare at least one image parameter of the at least two images.

3. The mobile device of claim 2, wherein the at least one image parameter is selected from the group consisting of a resolution ratio, a brightness, a contrast ratio, and a chroma value.

4. The mobile device of claim 2, wherein the image processor is further configured to determine that one of the at least one image parameter of one of the at least two images is superior to that of other images, define the one of the at least two images as a reference image, and adjust the one of the at least one image parameter of other images according to the corresponding image parameter of the reference image.

5. The mobile device of claim 4, wherein the image processor is further configured to further respectively adjust others of the at least one image parameter of other images according to the corresponding image parameters of the reference image.

6. The mobile device of claim 4, wherein the image processor is further configured to further determine that another of the at least one image parameter of one of the at least two images is superior to that of other images, define the one of the at least two images as a reference image, and adjust the another of the at least one image parameter of other images according to the corresponding image parameter of the reference image.

7. The mobile device of claim 2, wherein when the at least one image parameter comprises two or more image parameters, the image processor is further configured to determine that at least two of the two or more image parameters of one of the at least two images are superior to those of other images, define the one of the at least two images as a reference image, and adjust the at least two of the two or more image parameters of other images according to the corresponding image parameters of the reference image.

8. The mobile device of claim 7, wherein the image processor is further configured to further respectively adjust others of the two or more image parameters of other images according to the corresponding image parameters of the reference image.

9. The mobile device of claim 1, wherein the comparison circuit is further configured to compare at least one image parameter of the at least one overlapping portion.

10. The mobile device of claim 1, further comprising an image coder, wherein the image coder is configured to encode the at least images according to a uniform coding standard.

11. An image capturing method for a mobile device, the mobile device comprising at least two cameras, a comparison circuit and an image processor, and the method comprising:
simultaneously capturing at least two images by the at least two cameras, the at least two images having at least one overlapping portion;
comparing the at least two images and generating a comparison result by the comparison circuit according to the comparison; and
processing at least one of the at least two images, identifying the at least one overlapping portion and merging the at least two images to form an integrated image by the image processor, according to the comparison result.

12. The method of claim 11, further comprising comparing at least one image parameter of the at least two images before generating a comparison result.

13. The method of claim 12, wherein the at least one image parameter is selected from the group consisting of a resolution ratio, a brightness, a contrast ratio, and a chroma.

14. The method of claim 12, wherein processing at least one of the at least two images comprises determining that one of the at least one image parameter of one of the at least two images is superior to that of other images, defining the one of the at least two images as a reference image, and adjusting the one of the at least one image parameter of other images according to the corresponding image parameter of the reference image.

15. The method of claim 14, further comprising respectively adjusting others of the at least one image parameter of other images according to the corresponding image parameters of the reference image.

16. The method of claim 14, further comprising determining that another of the at least one image parameter of one of the at least two images is superior to that of other images, defining the one of the at least two images as a reference image, and adjusting the another of the at least one image parameter of other images according to the corresponding image parameter of the reference image.

17. The method of claim 12, wherein when the at least one image parameter comprises two or more image parameters, processing at least one of the at least two images comprises determining that at least two of the two or more image parameters of one of the at least two images are superior to those of other images, defining the one of the at least two images as a reference image, and adjusting the at least two of the two or more image parameters of other images according to the corresponding image parameters of the reference image.

18. The method of claim 17, further respectively adjusting others of the two or more image parameters of other images according to the corresponding image parameters of the reference image.

19. The method of claim 11, further comprising comparing at least one image parameter of the at least one overlapping portion before generating a comparison result.

20. The method of claim 11, further comprising encoding the at least images according to a uniform coding standard before comparing the at least two images.
